(19) United States
(12) Patent Application Publication
(10) Pub. No.: US 2023/0315947 A1
(43) Pub. Date: Oct. 5, 2023

(54) STRUCTURAL DESIGN USING FINITE-ELEMENT ANALYSIS

(71) Applicant: TENCENT AMERICA LLC, Palo Alto, CA (US)

(72) Inventors: Zherong PAN, Shenzhen (CN); Xifeng Gao, Shenzhen (CN); Kui Wu, Shenzhen (CN)

(21) Appl. No.: 17/714,046

(22) Filed: Apr. 5, 2022

(51) Int. Cl. G06F 30/23; G06F 30/10

(52) U.S. Cl. CPC G06F 30/23; G06F 30/10; G06F 2111/04

(57) ABSTRACT

The various embodiments described herein include methods, devices, and systems for optimizing structural design. In some embodiments, a method includes obtaining a set of constraints for a structure, including an external force constraint; and partitioning a design space for the structure into a plurality of cells. The method further includes, in accordance with the external force constraint being applied to the structure: obtaining an approximate finite element analysis (FEA) solution for the plurality of cells based on the set of constraints; performing a sensitivity analysis on the plurality of cells based on the approximate FEA solution; and updating a structural model for the structure based on the sensitivity analysis of the plurality of cells.

### TECHNICAL FIELD

This relates generally to structural design and particularly to optimizing structural design using finite-element analysis.

### BACKGROUND

Topology optimization (TO) is a process of searching for structures of a mechanical object to improve or maximize its resistance to external forces under object weight constraints. Topology optimization can reduce the cost and improve the quality of manufactured mechanical objects. A physical model is generally used by a topology optimizer to describe object deformations under external forces. A topology optimizer may iteratively update the structure of a mechanical object until an optimal structure is found. During each iteration, the topology optimizer may use the physical model to find object deformations, which may then be used to perform sensitivity analysis and compute the direction of structure updates.

Thus, topology optimization can be an important step for automatic design of mechanical parts. Some TO approaches use a Finite Element Analysis (FEA) approach. An FEA approach is a procedure to divide a mechanical object into a set of nodes plus elements and represent physical model as a set of equations. Accordingly, an FEA approach also involves techniques for solving the set of equations. However, conventional FEA approaches require large amount of computational resources. In particular, conventional FEA approaches have a high iterative cost. The iterative cost includes the computational time and algorithmic complexity for a topology optimizer to update the mechanical object structure once.

### SUMMARY

The present disclosure describes TO approaches that incur lower iterative costs. Unlike conventional approaches that require exact inversions of large FEA system matrices at every iteration, some TO approaches described herein reformulate the problem as a bilevel optimization that can be solved using a first-order algorithm. For example, some TO approaches described herein only invert the system matrix approximately. In this way, a lower iterative cost is incurred, and users can preview the TO results interactively for fast design updates. During topology optimization users may prefer to quickly preview and update a partially optimized mechanical structure. Accordingly, a preferred topology optimizer incurs a low iterative cost (to allow users preview the partially results) and converges to locally optimal structures.

Some embodiments include a topology optimizer with a low iterative cost and guaranteed convergence using a Solid Isotropic Material with Penalization (SIMP) model. A SIMP model includes a set of assumptions on the structure representation of a mechanical object and the underlying physical model. A SIMP model assumes that a mechanical object is divided into a set of elements, and the structure is represented by the extent to which each element is filled with material. Further, a SIMP model assumes the material responds isotropically to external forces and the relationship between force and deformation is linear.

An example optimizer uses an FEA approach to divide the mechanical object into a set of nodes plus elements and iteratively updates the structure of the object. In this example, during each iteration, a FEA is performed to derive a set of linear equations representing the physical model. Then an approximate (partial) solution is found for the set of linear equations. Next, the partial solution is used to perform a sensitivity analysis, which is used to update the object structure.

Accordingly, in one aspect, some embodiments include a method of optimizing a structural design performed at a computing system having memory and one or more processors, the method including: (i) obtaining a set of constraints for a structure, including an external force constraint; (ii) partitioning a design space for the structure into a plurality of cells; and (iii) in accordance with the external force constraint being applied to the structure: (a) obtaining an approximate finite element analysis (FEA) solution for the plurality of cells based on the set of constraints; (b) performing a sensitivity analysis on the plurality of cells based on the approximate FEA solution; and (c) updating a structural model for the structure based on the sensitivity analysis of the plurality of cells.

In another aspect, some embodiments include a computing system, including: one or more processors; memory; and one or more programs stored in the memory and configured for execution by the one or more processors, the one or more programs comprising instructions for: (i) obtaining a set of constraints for a structure, including an external force constraint; (ii) partitioning a design space for the structure into a plurality of cells; and (iii) in accordance with the external force constraint being applied to the structure: (a) obtaining an approximate finite element analysis solution for the plurality of cells based on the set of constraints; (b) performing a sensitivity analysis on the plurality of cells based on the approximate FEA solution; and (c) updating a structural model for the structure based on the sensitivity analysis of the plurality of cells.

Thus, systems and devices are provided with methods for structural design optimization, thereby increasing the effectiveness, efficiency, and user satisfaction with such systems and devices. Such systems, devices, and methods optionally complement or replace conventional systems, devices, and methods for structural design optimization.

### BRIEF DESCRIPTION OF THE DRAWINGS

For a better understanding of the various described embodiments, reference should be made to the Detailed Description below, in conjunction with the following drawings in which like reference numerals refer to corresponding parts throughout the figures.

FIGS. 1A-1F are diagrams illustrating an example structural design procedure in accordance with some embodiments.

FIG. 2 is a chart illustrating example design optimization over time in accordance with some embodiments.

FIG. 3 is a block diagram illustrating an example computing system in accordance with some embodiments.

FIGS. 4A-4C are flowcharts illustrating an example method for structural design optimization in accordance with some embodiments.

### DETAILED DESCRIPTION

Reference will now be made in detail to embodiments, examples of which are illustrated in the accompanying drawings. In the following detailed description, numerous specific details are set forth in order to provide a thorough understanding of the various described embodiments. However, it will be apparent to one of ordinary skill in the art that the various described embodiments may be practiced without these specific details. In other instances, well-known methods, procedures, components, circuits, and networks have not been described in detail so as not to unnecessarily obscure aspects of the embodiments.

Several techniques have contributed to the trend of lightweight, low-cost mechanical designs. For example, commodity-level additive manufacturing has been improved with 3D printers and user-friendly modeling software, making it possible for inexperienced users to prototype devices, consumer products, and low-end robots. While the appearance of a mechanical part can be intuitive to perceive and modify, other essential properties, such as structural robustness, fragility, vibration frequencies, and manufacturing cost, are harder to visualize and manage. These properties can highly impact the ultimate performance criteria, including flexibility, robotic maneuverability, and safety. For example, the mass and inertia of a collaborative robot may need to be carefully controlled to avoid causing harm to a person if they collide. As another example, for some manipulators on spacecrafts, the length of each part should be optimized to maximize the end-effector reachability while meeting strict weight limits. For these reasons, mechanical designers rely on TO procedures to identify an optimal structure for mechanical parts (e.g., by tuning their center-of-mass, inertia, infill pattern, and/or material distribution). However, current TO procedures can pose a computational bottleneck. For example, some TO procedures rely on FEA to predict the relationship between the extrinsic (e.g., boundary) loads and intrinsic status (e.g., stress, strain, and energy densities) of a mechanical part. As mentioned above, FEA predictions are made by solving systems of equations (e.g., linear or non-linear) during each iteration of the topology optimization procedure. In some situations, the design space and resulting system size can be very large due to the requirement of designing fine-grained material shapes. Thus, in some situations, even after aggressive optimization, the total time spent on FEA is typically at the level of hours.

The SIMP model is generally used to search for fine-grained geometric shapes by optimizing the infill levels. In some conventional TO approaches, the computation resources are predominated by solving the system of equations to the machine precision. In some scenarios such precision for intermediary TO iterations is unnecessary as the system need only be exactly solved on final convergence. To this end, the present disclosure describes embodiments that maintain an approximate solution that is refined over iterations. Such a TO approach corresponds to a bilevel reformulation of the SIMP problems. Some embodiments include a first-order algorithm to solve such bilevel problems with guaranteed convergence to a first-order critical point of moderate accuracy. Compared with conventional TO approaches, the first-order algorithm incurs a lower iterative cost of O(E log E), where E is the number of decision variables. This allows the mechanical designers to interactively preview the TO results and accelerate the loops of design refinement. Moreover, some embodiments include a GPU-based architectures that achieve an asymptotic iterative cost of O(log E).

Some embodiments include an assumption that the boundaries of a mechanical object are defined. For example, the boundary of a mechanical object may be a contour defining a boundary of a region the object can occupy. In addition to a boundary contour, some embodiments assume that fixed points and external forces are labeled by a user. The fixed points are points fixed to other objects that cannot move. The external forces are the forces that will be applied to the object during use. Some embodiments assume that a user has defined a maximal amount of material that can be used to manufacture the object. Thus, in accordance with some embodiments, TO approaches described herein generate locally optimal internal structures given a set of external forces on a mechanical object and the maximal amount of material.

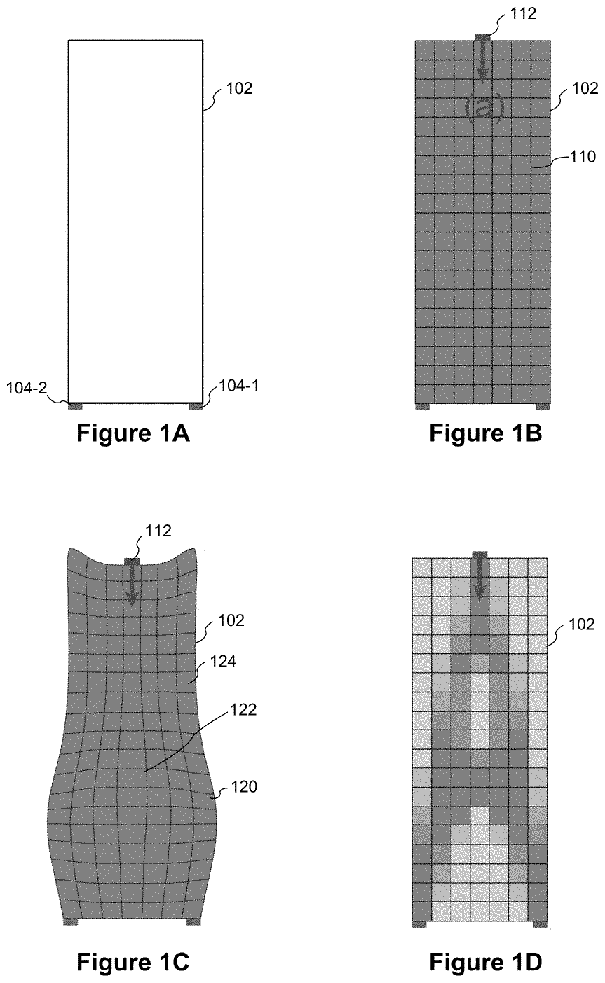

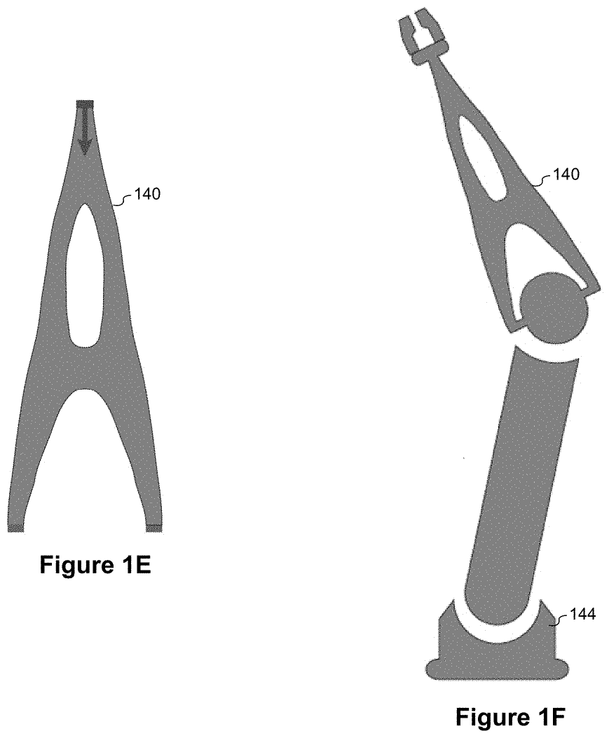

Turning now to the figures, FIGS. 1A-1F are diagrams illustrating an example structural design procedure in accordance with some embodiments. The optimized object in the example of FIGS. 1A-1F is a link in a robotic arm.

FIG. 1A shows a region 102 that a mechanical object can occupy, and fixed points 104-1 and 104-2 indicating where the mechanical object is fixed and cannot move. In some embodiments, a user defines the region 102 and the fixed points 104.

FIG. 1B shows the region 102 partitioned into a plurality of unit cells 110, and an external force 112 to be applied to the mechanical object. For example, a user provides the external force 112 to be applied to the object and locations where the object will be fixed (fixed points 104-1 and 104-2).

FIG. 1C shows an object deformation 120 responsive to the force 112, e.g., computed via an FEA system of equations. As illustrated in FIG. 1C, a subset of the unit cells 110 deform more than other unit cells in response to application of the force 112. For example, FIG. 1C shows the unit cell 122 deforming more than the unit cell 124.

FIG. 1D shows an approximate gradient within the region 102, e.g., computed via a sensitivity analysis. In some embodiments, a sensitivity analysis is performed on an approximate solution to the FEA system of equations to compute an update direction (also sometimes called a search direction) for the object.

FIG. 1E shows an object 140 (e.g., a locally optimal structure) generated via a TO procedure (e.g., the FEA and sensitivity analysis). In some embodiments, the object 140 is generated by repeating the approximate FEA system solve, the sensitivity analysis, and the structural updates until a convergent structural model is obtained. FIG. 1F shows the object 140 used as a link in a robotic arm 144 in accordance with some embodiments.

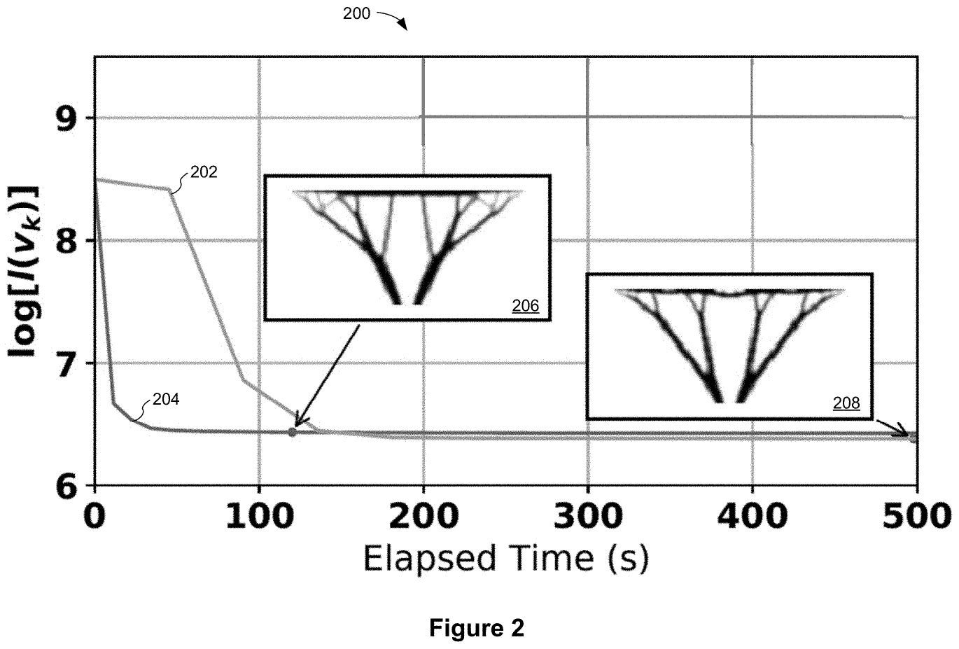

FIG. 2 is a chart 200 illustrating example object optimizations over time in accordance with some embodiments. The chart 200 plots a logarithm of an energy function l(vₖ) over time, and includes a TO approach 204 (utilizing an approximate FEA system solution) and a TO approach 202 (utilizing an exact FEA system solution). As shown in FIG. 2, the TO approach 204 converges on an approximate solution (e.g., illustrated in image 206) quicker than the TO approach 202 (e.g., illustrated in image 208), which allows the user to preview the results more quickly and interactively.

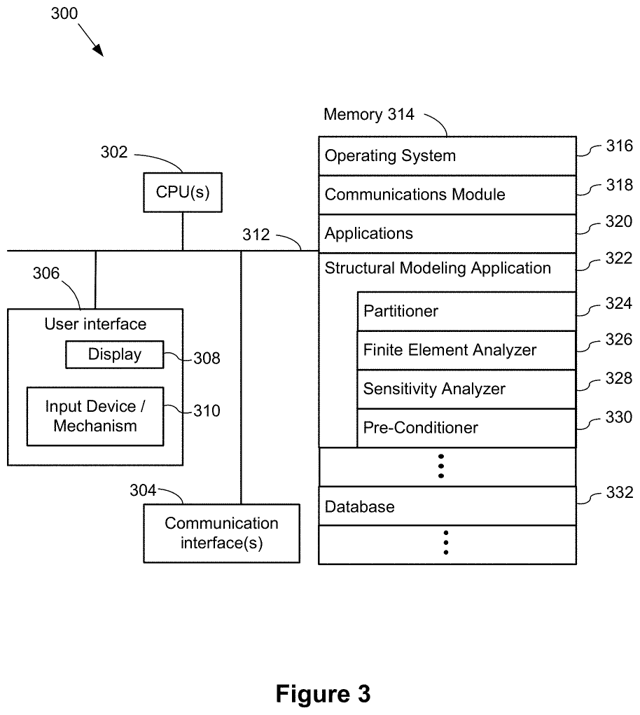

FIG. 3 is a block diagram illustrating a computing system 300 in accordance with some embodiments. Various examples of the computing system 300 include a desktop computer, a laptop computer, a tablet computer, a server system, and other computing devices that have a processor capable of running the structural modeling application 322. The computing system 300 typically includes one or more processing units/cores (CPUs) 302 for executing modules, programs, and/or instructions stored in memory 314 and thereby performing processing operations; one or more network or other communications interfaces 304; the memory 314; and one or more communication buses 312 for interconnecting these components. The communication buses 312 may include circuitry that interconnects and controls communications between system components.

The computing system 300 optionally includes a user interface 306 comprising a display device 308 and one or more input devices or mechanisms 310. In some embodiments, the input devices include a keyboard and/or mouse. In some embodiments, the input devices include a “soft” keyboard, which is displayed as needed on the display device 308, enabling a user to “press keys” that appear on the display 308. In some embodiments, the display 308 and input devices 310 include a touch screen display (also called a touch sensitive display).

In some embodiments, the memory 314 includes high-speed random-access memory, such as DRAM, SRAM, DDR RAM or other random-access solid-state memory devices. In some embodiments, the memory 314 includes non-volatile memory, such as one or more magnetic disk storage devices, optical disk storage devices, flash memory devices, or other non-volatile solid state storage devices. In some embodiments, the memory 314 includes one or more storage devices remotely located from the CPU(s) 302. The memory 314, or alternately the non-volatile memory device(s) within the memory 314, is, or includes, a non-transitory computer readable storage medium. In some embodiments, the memory 314, or the computer readable storage medium of the memory 314, stores the following programs, modules, and data structures, or a subset thereof:
an operating system 316, which includes procedures for handling various basic system services and for performing hardware dependent tasks;
a communications module 318, which is used for connecting the computing system 300 to other computers and devices via the one or more communication network interfaces 304 (wired or wireless) and one or more communication networks, such as the Internet, other wide area networks, local area networks, metropolitan area networks, and so on;
one or more applications 320 that perform particular tasks or sets of tasks for a user (e.g., word processors, media players, web browsers, and communication platforms);
a structural modeling application 322 for modeling and/or optimizing objects (e.g., structural or mechanical objects). In accordance with some embodiments, the structural modeling application 322 includes a partitioner 324 for partitioning a design region into a plurality of unit cells, a finite element analyzer 326 for generating an FEA system of equations, a sensitivity analyzer 328 for applying a sensitivity analysis to an FEA output, and a pre-conditioner 330 for applying a pre-conditioner to the FEA system of equations; and
one or more databases 332, which are used by the applications 320 and/or the structural modeling application 322.

Each of the above identified executable modules, applications, or sets of procedures may be stored in one or more of the previously mentioned memory devices, and corresponds to a set of instructions for performing a function described above. The above identified modules or programs (i.e., sets of instructions) need not be implemented as separate software programs, procedures, or modules, and thus various subsets of these modules may be combined or otherwise re-arranged in various embodiments. In some embodiments, the memory 314 stores a subset of the modules and data structures identified above. Furthermore, the memory 314 may store additional modules or data structures not described above.

Although FIG. 3 shows a computing system 300, FIG. 3 is intended more as a functional description of the various features that may be present rather than as a structural schematic of the embodiments described herein. In practice, and as recognized by those of ordinary skill in the art, items shown separately could be combined and some items could be separated.

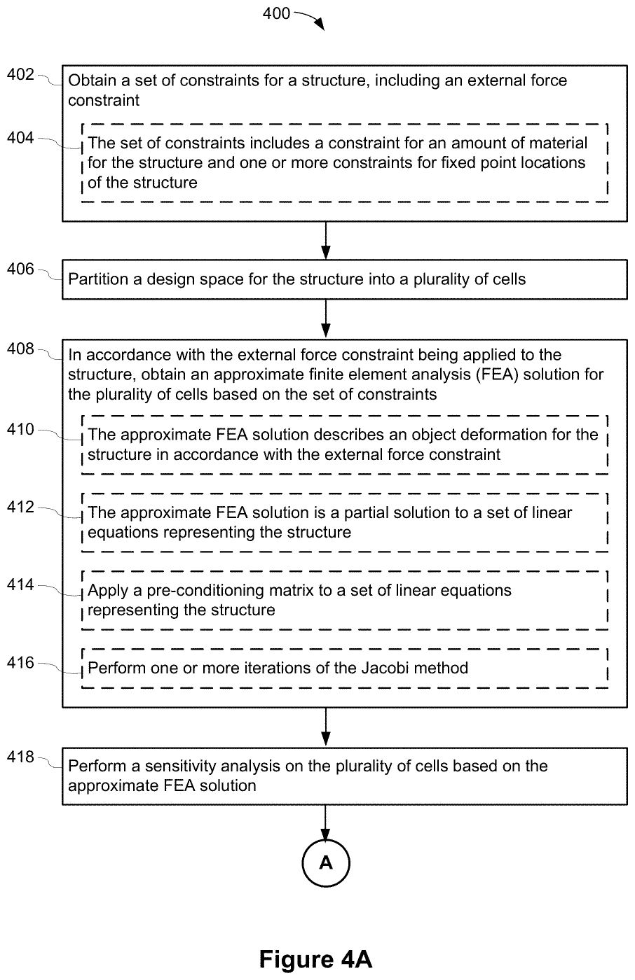

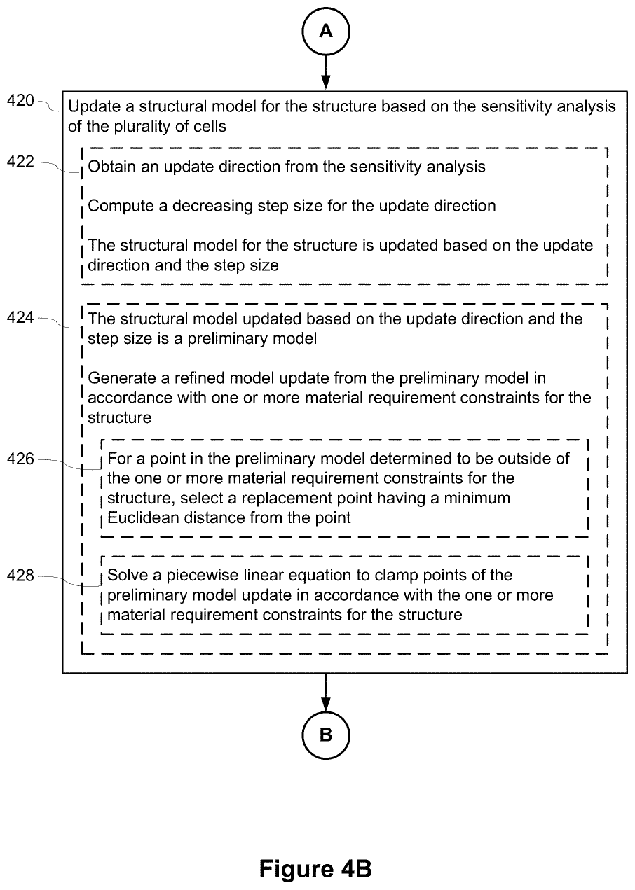

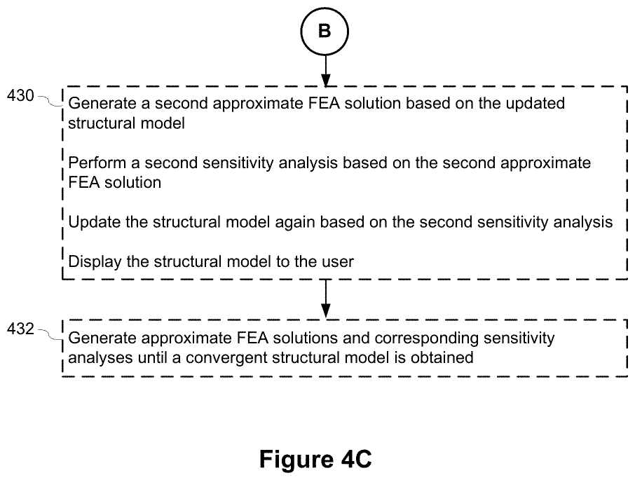

FIGS. 4A-4C are flowcharts illustrating a method 400 for generating output meshes of 3D objects in accordance with some embodiments. The method 400 is performed at a computing system (e.g., the computing system 300) having one or more processors and memory. In some embodiments, the memory stores one or more programs configured for execution by the one or more processors.

The computing system obtains (402) a set of constraints for a structure (e.g., a mechanical object), including an external force constraint (e.g., the force 112). In some embodiments, the computing system obtains the set of constraints from a user (e.g., via a graphical user interface). In some embodiments, the set of constraints includes (404) a constraint for an amount of material for the structure and one or more constraints for fixed point locations of the structure (e.g., the fixed points 104-1 and 104-2).

The computing system partitions (406) a design space (e.g., the region 102) for the structure into a plurality of cells (e.g., the cells 110). The computing system obtains (408) an approximate finite element analysis (FEA) solution for the plurality of cells based on the set of constraints in accordance with the external force constraint being applied to the structure. In some embodiments, the approximate FEA solution describes (410) an object deformation for the structure (e.g., as illustrated in FIG. 1C) in accordance with the external force constraint. In some embodiments, the approximate FEA solution is (412) a partial solution to a set of linear equations representing the structure.

In some embodiments, the computing system applies (414) a pre-conditioning matrix (e.g., a symmetric positive-definite matrix) to a set of linear equations representing the structure.

In some embodiments, the computing system performs (416) one or more iterations of the Jacobi method. For example, an algorithm is applied to determine solutions of a strictly diagonally dominant system of linear equations, where each diagonal element is solved for, and an approximate value is plugged in.

The computing system performs (418) a sensitivity analysis on the plurality of cells based on the approximate FEA solution (e.g., as illustrated in FIG. 1D). For example, a partial solution of the FEA set of equations is used to perform the sensitivity analysis.

The computing system updates (420) a structural model for the structure based on the sensitivity analysis of the plurality of cells. For example, a projected gradient is used to update the infill levels along the search direction with an adaptive step size.

In some embodiments, the computing system obtains (422) an update direction from the sensitivity analysis and computes a decreasing step size for the update direction, where the structural model for the structure is updated based on the update direction and the step size. For example, a series of step sizes are used that decrease over iterations to ensure convergence.

In some embodiments, the structural model updated based on the update direction and the step size is (424) a preliminary model, and the computing system generates a refined model update from the preliminary model in accordance with one or more material requirement constraints for the structure. In some embodiments, for a point in the preliminary model determined to be outside of the one or more material requirement constraints for the structure, the computing system selects (426) a replacement point having a minimum Euclidean distance from the point. For example, a projected gradient is used to update the infill levels along the search direction with an adaptive step size. Such an update may lead to an infill level outside the feasible domain. To correct this, the infill level is projected back to the closest point in the feasible domain under Euclidean distance in accordance with some embodiments. In some embodiments, the computing system solves (428) a piecewise linear equation to clamp points of the preliminary model update in accordance with the one or more material requirement constraints for the structure.

In some embodiments, the computing system: (i) generates (430) a second approximate FEA solution based on the updated structural model; (ii) performs a second sensitivity analysis based on the second approximate FEA solution; (iii) updates the structural model again based on the second sensitivity analysis; and (iv) displays the structural model to the user. In some embodiments, the computing system generates (432) approximate FEA solutions and corresponding sensitivity analyses until a convergent structural model is obtained.

In light of these principles, we now turn to certain embodiments.
(A1) In one aspect, some embodiments include a method (e.g., the method 400) performed at a computing system (e.g., the computing system 300) having memory and one or more processors. The method includes: (a) obtaining a set of constraints for a structure, including an external force constraint (e.g., the force 112); (b) partitioning a design space for the structure into a plurality of cells (e.g., the cells 110); and (c) in accordance with the external force constraint being applied to the structure: (i) obtaining an approximate finite element analysis (FEA) solution (e.g., a partial solution to the FEA set of equations) for the plurality of cells based on the set of constraints; (ii) performing a sensitivity analysis on the plurality of cells based on the approximate FEA solution; and (iii) updating a structural model for the structure based on the sensitivity analysis of the plurality of cells. For example, the method includes applying a Solid Isotropic Material with Penalization (SIMP) model. In some embodiments, the structural model is displayed to a user. In some embodiments, the structural model is displayed (e.g., updated) after a preset number of iterations (e.g., loops). In some embodiments, the set of constraints are obtained from a user (e.g., via the user interface 306). In some embodiments, the method is performed by the structural modeling application 322.
(A2) In some embodiments of A1, the method further includes, after obtaining the structural model: (i) generating a second approximate FEA solution (e.g., using the finite element analyzer 326) based on the updated structural model; (ii) performing a second sensitivity analysis (e.g., using the sensitivity analyzer 328) based on the second approximate FEA solution; (iii) updating the structural model again based on the second sensitivity analysis; and (iv) after updating the structural model again, displaying the structural model to the user (e.g., displaying the structural model at the display 308). In some embodiments, the updated structural model is displayed to the user along with the set of constraints, and optionally, an affordance for editing the set of constraints. For example, the user can inspect the updated structural model and update the set of constraints to correct for an issue the user has noticed with the updated structural model.
(A3) In some embodiments of A2, the method further includes repeating generating approximate FEA solutions and corresponding sensitivity analyses until a convergent structural model is obtained. In some embodiments, the updated structural model is displayed to a user each iteration. In some embodiments, in addition to displaying the updated model, the user provided an affordance to stop the repeating and/or update the set of constraints.
(A4) In some embodiments of any of A1-A3, the approximate FEA solution describes an object deformation for the structure in accordance with the external force constraint (e.g., as illustrated in FIG. 1C).
(A5) In some embodiments of any of A1-A4, the approximate FEA solution includes a partial solution to a set of linear equations representing the structure.
(A6) In some embodiments of any of A1-A5, the set of constraints includes a constraint for an amount of material for the structure and one or more constraints for fixed point locations of the structure (e.g., the fixed points 104).
(A7) In some embodiments of any of A1-A6, the method further includes: (i) obtaining an update direction from the sensitivity analysis; and (ii) computing a decreasing step size for the update direction; and the structural model for the structure is updated based on the update direction and the step size.
(A8) In some embodiments of A7, the structural model updated based on the update direction and the step size is a preliminary model; and the method further includes generating a refined model update from the preliminary model in accordance with one or more material requirement constraints for the structure.
(A9) In some embodiments of A8, generating the refined model update includes, for a point in the preliminary model determined to be outside of the one or more material requirement constraints for the structure, selecting a replacement point having a minimum Euclidean distance from the point.
(A10) In some embodiments of any of A8 or A9, generating the refined model update includes solving a piecewise linear equation to clamp points of the preliminary model update in accordance with the one or more material requirement constraints for the structure.
(A11) In some embodiments of any of A1-A10, obtaining the approximate FEA solution includes applying a pre-conditioning matrix (e.g., using the pre-conditioner 330) to a set of linear equations representing the structure (e.g., a positive, definite preconditioner having eigenvalues bounded away from zero). In some embodiments, an approximate solver, represented as a pre-conditioning matrix, is used to solve the FEA set of equations. For example, the preconditioner is applied once to derive an approximate solution. After deriving the approximate solution, a sensitivity analysis may be applied, and the search direction can be computed.
(A12) In some embodiments of any of A1-A11, obtaining the approximate FEA solution includes performing one or more iterations of the Jacobi method.
(A13) In some embodiments of any of A1-A12, obtaining an exact FEA solution requires a super-linear computational complexity and obtaining the approximate FEA solution requires a linear computational complexity.

In another aspect, some embodiments include a computing system including one or more processors and memory coupled to the one or more processors, the memory storing one or more programs configured to be executed by the one or more processors, the one or more programs including instructions for performing any of the methods described herein (e.g., A1-A13 above).

In yet another aspect, some embodiments include a non-transitory computer-readable storage medium storing one or more programs for execution by one or more processors of a computing system, the one or more programs including instructions for performing any of the methods described herein (e.g., A1-A13 above).

Many modifications and variations of this disclosure can be made without departing from its spirit and scope, as will be apparent to those skilled in the art. The specific embodiments described herein are offered by way of example only, and the disclosure is to be limited only by the terms of the appended claims, along with the full scope of equivalents to which such claims are entitled.

It will also be understood that, although the terms first, second, etc. are, in some instances, used herein to describe various elements, these elements should not be limited by these terms. These terms are only used to distinguish one element from another. For example, a first object could be termed a second object, and, similarly, a second object could be termed a first object, without departing from the scope of the various described embodiments. The first object and the second object are both objects, but they are not the same object unless explicitly stated as such.

The terminology used in the description of the various described embodiments herein is for the purpose of describing particular embodiments only and is not intended to be limiting. As used in the description of the various described embodiments and the appended claims, the singular forms “a”, “an” and “the” are intended to include the plural forms as well, unless the context clearly indicates otherwise. It will also be understood that the term “and/or” as used herein refers to and encompasses any and all possible combinations of one or more of the associated listed items. It will be further understood that the terms “includes,” “including,” “comprises,” and/or “comprising,” when used in this specification, specify the presence of stated features, integers, steps, operations, elements, and/or components, but do not preclude the presence or addition of one or more other features, integers, steps, operations, elements, components, and/or groups thereof.

The foregoing description, for purpose of explanation, has been described with reference to specific embodiments. However, the illustrative discussions above are not intended to be exhaustive or to limit the scope of the claims to the precise forms disclosed. Many modifications and variations are possible in view of the above teachings. The embodiments were chosen in order to best explain the principles underlying the claims and their practical applications, to thereby enable others skilled in the art to best use the embodiments with various modifications as are suited to the particular uses contemplated.

What is claimed is:

1. A method of optimizing a structural design performed at a computing system having memory and one or more processors, the method comprising:
obtaining a set of constraints for a structure, including an external force constraint;
partitioning a design space for the structure into a plurality of cells; and
in accordance with the external force constraint being applied to the structure:
obtaining an approximate finite element analysis (FEA) solution for the plurality of cells based on the set of constraints;
performing a sensitivity analysis on the plurality of cells based on the approximate FEA solution; and
updating a structural model for the structure based on the sensitivity analysis of the plurality of cells.

2. The method of claim 1, further comprising, after obtaining the structural model:
generating a second approximate FEA solution based on the updated structural model;
performing a second sensitivity analysis based on the second approximate FEA solution;
updating the structural model again based on the second sensitivity analysis; and
after updating the structural model again, displaying the structural model to a user.

3. The method of claim 2, further comprising repeating generating approximate FEA solutions and corresponding sensitivity analyses until a convergent structural model is obtained.

4. The method of claim 1, wherein the approximate FEA solution describes an object deformation for the structure in accordance with the external force constraint.

5. The method of claim 1, wherein the approximate FEA solution comprises a partial solution to a set of linear equations representing the structure.

6. The method of claim 1, wherein the set of constraints comprises a constraint for an amount of material for the structure and one or more constraints for fixed point locations of the structure.

7. The method of claim 1, further comprising:
obtaining an update direction from the sensitivity analysis;
computing a decreasing step size for the update direction; and
wherein the structural model for the structure is updated based on the update direction and the step size.

8. The method of claim 7, wherein the structural model updated based on the update direction and the step size is a preliminary model; and
the method further comprises generating a refined model update from the preliminary model in accordance with one or more material requirement constraints for the structure.

9. The method of claim 8, wherein generating the refined model update comprises, for a point in the preliminary model determined to be outside of the one or more material requirement constraints for the structure, selecting a replacement point having a minimum Euclidean distance from the point.

10. The method of claim 8, wherein generating the refined model update comprises solving a piecewise linear equation to clamp points of the preliminary model update in accordance with the one or more material requirement constraints for the structure.

11. The method of claim 1, wherein obtaining the approximate FEA solution comprises applying a pre-conditioning matrix to a set of linear equations representing the structure.

12. The method of claim 1, wherein obtaining the approximate FEA solution comprises performing one or more iterations of the Jacobi method.

13. The method of claim 1, wherein obtaining an exact FEA solution requires a super-linear computational complexity and obtaining the approximate FEA solution requires a linear computational complexity.

14. A computing system, comprising:
one or more processors;
memory; and
one or more programs stored in the memory and configured for execution by the one or more processors, the one or more programs comprising instructions for:
obtaining a set of constraints for a structure, including an external force constraint;
partitioning a design space for the structure into a plurality of cells; and
in accordance with the external force constraint being applied to the structure:
obtaining an approximate finite element analysis (FEA) solution for the plurality of cells based on the set of constraints;
performing a sensitivity analysis on the plurality of cells based on the approximate FEA solution; and
updating a structural model for the structure based on the sensitivity analysis of the plurality of cells.

15. The computing system of claim 14, wherein the one or more programs further comprise instructions for, after obtaining the structural model:
generating a second approximate FEA solution based on the updated structural model;
performing a second sensitivity analysis based on the second approximate FEA solution;
updating the structural model again based on the second sensitivity analysis; and
after updating the structural model again, displaying the structural model to a user.

16. The computing system of claim 15, wherein the one or more programs further comprise instructions for repeating generating approximate FEA solutions and corresponding sensitivity analyses until a convergent structural model is obtained.

17. The computing system of claim 15, wherein obtaining the approximate FEA solution comprises applying a pre-conditioning matrix to a set of linear equations representing the structure.

18. A non-transitory computer-readable storage medium storing one or more programs configured for execution by a computing device having one or more processors, memory, and a display, the one or more programs comprising instructions for:
obtaining a set of constraints for a structure, including an external force constraint;
partitioning a design space for the structure into a plurality of cells; and
in accordance with the external force constraint being applied to the structure:
obtaining an approximate finite element analysis (FEA) solution for the plurality of cells based on the set of constraints;
performing a sensitivity analysis on the plurality of cells based on the approximate FEA solution; and
updating a structural model for the structure based on the sensitivity analysis of the plurality of cells.

19. The non-transitory computer-readable storage medium of claim 18, wherein the one or more programs further comprise instructions for, after obtaining the structural model:
generating a second approximate FEA solution based on the updated structural model;
performing a second sensitivity analysis based on the second approximate FEA solution;
updating the structural model again based on the second sensitivity analysis; and
after updating the structural model again, displaying the structural model to a user.

20. The non-transitory computer-readable storage medium of claim 19, wherein the one or more programs further comprise instructions for repeating generating approximate FEA solutions and corresponding sensitivity analyses until a convergent structural model is obtained.
